(19) United States
(12) Patent Application Publication
(10) Pub. No.: US 2012/0280568 A1
(43) Pub. Date: Nov. 8, 2012

(54) BATTERY PRODUCTION DEVICE

(75) Inventors: Tim Schaefer, Harztor (DE); Andreas Gutsch, Luedinghausen (DE)

(73) Assignee: Li-Tec Battery GmbH, Kamenz (DE)

(21) Appl. No.: 13/510,482

(22) PCT Filed: Nov. 11, 2010
(86) PCT No.: PCT/EP2010/006878

§ 371 Date: Jul. 16, 2012

(30) Foreign Application Priority Data
Nov. 20, 2009 (DE) 10 2009 054 078.4

(51) Int. Cl. H02J 1/00

(52) U.S. Cl. 307/43

(57) ABSTRACT

A battery production device, in particular a forming device formation device (1) for forming the formation of electrochemical cells (4), comprising a production unit, in particular a receiving device (3) for receiving at least one electrochemical cell (4), in particular a plurality of electrochemical cells (4), a power network connecting device (5), by means of which the battery production device can draw electrical energy from a power network (2), in particular a public power network, and can emit electrical energy to the power network, a control device (7) for controlling at least parts of the battery production, characterised in that the control device (7) is constructed in such a way that the electric power drawn from the power network (2) and/or the electrical power emitted to the power network (2) can be controlled as a function of the services power offered in the power network, in particular can be controlled as a function of the temporary services power offered in the power network.

The present invention relates to a battery production device, in particular a formation device for the formation of electrochemical cells.

Renewable energies, such as for example wind energy or solar energy have the disadvantage of fluctuating power output. In the case of corresponding weather conditions, wind power installations or solar power installations can output a high power, whilst in the event of a corresponding change of the weather situation, the power output can drop to a very low level with a short time. Fluctuations of this type in the power offering of a power network can lead to bottlenecks in energy supply, particularly in the case of very large consumers of electrical energy. Further, supply bottlenecks can lead to a temporary rise of the costs of energy procurement. Battery productions devices, which also require electrical energy for the charging of batteries, must be adapted to the fluctuating power offering.

DE 1 671 821 discloses an arrangement for the formation of rechargeable batteries. Energy contained in the rechargeable battery can be fed back into the alternating current network in a lossless manner without further additional power sources.

It is the object of the present invention to provide an improved battery production device.

This object is achieved by means of a battery production device, in particular a formation device for the formation of electrochemical cells, comprising a production unit, in particular a receiving device for receiving at least one electrochemical cell, in particular for receiving a plurality of electrochemical cells, a power network connecting device, by means of which the battery production device can draw electrical energy from a power network, in particular a public power network, and can emit electrical energy to the power network. A control device of the battery production device, which is used to control at least parts of the battery production, is comprised. The control device is constructed in such a manner that the energy drawn from the power network and/or the energy output to the power network can be controlled as a function of the power offering in the power network. Power offering in particular means the temporal power offering.

In the sense of the present invention, a battery production device can be understood as meaning any device which can be used in the context of the production of electrochemical cells or battery arrangements containing at least one electrochemical cell. The production of an electrochemical cell or a battery arrangement containing at least one electrochemical cell relates in this case to the process of the transfer of natural or pre-produced base materials, if appropriate using energy and further work equipment until the electrochemical cell or the battery arrangement containing at least one electrochemical cell is finished as a finished product which can be used as intended. A direct production process takes place in the production unit. The remaining devices, such as e.g. the control device or the power network connecting device are not directly involved in the process of production. The formation of electrochemical cells can be regarded as an essential constituent of battery production. The formation can be used for creating special surface layers on the electrodes of the electrochemical cells, essential mechanical changes not necessarily having to be performed on the electrochemical cell. The formation of electrochemical cells can comprise multiple charging and discharging of the electrochemical cells. The receiving device for electrochemical cells to be formatted constitutes a possible production unit in this case.

In the sense of the invention, an electrochemical cell is understood as meaning a device which is also used for storing chemical energy and for emitting electrical energy. To this end, the electrochemical cell according to the invention can have an electrode stack or an electrode winding which is isolated by means of an envelope in a substantially gas- and liquid-tight manner with respect to the envelope. Also, the electrochemical cell can be configured to absorb electrical energy during charging. One speaks then of a secondary cell or a rechargeable battery.

As a result of the control device being able to control the electrical energy drawn or emitted as a function of the power offering, the battery production device can be adjusted to fluctuations of the power offering. Provision can be made in this case for more electrical power to be drawn in the case of an increased power offering than in the case of a low power offering. Further, provision can be made for less power to be emitted to the power network in the case of a high power offering or for more electrical power to be emitted to the power network in the case of a low power offering. A high power offering may be present in the case of network underload and a low power offering may be present in the case of network overload.

In the process of the formation of electrochemical cells, admittedly electrical energy is drawn form an energy source, in particular a power network or an energy storage device. A large part of this energy is required for charging the electrochemical cells. This energy is, with the exception of losses of any type, consequently not consumed, but rather only converted into chemical energy. At another point in time, the electrochemical cell to be formatted is discharged again, so that electrical energy can be made available. Due to the multiplicity of electrochemical cells to be formatted on a large scale, a controlling of the battery production device can make a contribution to the stabilisation of power networks with regards to the power drawn or to be emitted. Furthermore, cost advantages arise from the use of inexpensive power generation costs in the case of network underload or high fees amounts for power which is fed into the power network in the case of network overload.

Preferably, the battery production device has an energy storage device. An energy storage device can be understood as meaning any device which can store energy in particular for purposes of later usage or other discharge. An energy storage device can convert the electrical energy into other energy forms, such as for example mechanical and/or chemical energy. A reconversion of the energy into electrical energy is preferably provided. The energy storage device can preferably comprise a number of electrochemical cells, particularly secondary cells.

By providing an energy storage device, parts of the battery production device which require electrical energy, particularly the production unit, can at least temporarily be provided with sufficient power independently of the power offering in the power network in that power can alternatively be provided by means of the energy storage device. Likewise, the production unit can emit electrical energy independently of the power offering in the power network in certain operating states, as the production unit can also emit electrical energy to the energy storage device. The battery production device can in this case draw power to a greater extent from the power network when the temporary power offering is inexpensive for drawing power, and in the process also conduct the power into the energy storage device if at this point in time there is no demand for power from the production unit or the demand only exists to a reduced extent. The energy stored in the energy storage device can be used at any desired point in time at the production unit. Alternatively, the energy stored in the energy storage device can be emitted at any desired time to the power network. One or a plurality of electrochemical cells can be constituents of the energy storage device.

Preferably, the energy storage device and the production unit are formed by a common device. In this case, provision may in particular be made for the energy storage device or the production unit to be formed from similar components in each case. Alternatively or in combination therewith, provision can be made for it to be possible for one component of the battery production device to be assigned to either the energy storage device or the production unit, depending on the operating state. In another operating state, this component can then be assigned to the respective other, namely the production unit or the energy storage device. This is true in particular for a receiving device for electrochemical cells, on which, in an operating state, electrochemical cells to be formatted can be attached. In an operating state temporally downstream of the formation of the electrochemical cells, the electrochemical cell formatted in the previous operating state can furthermore remain in the receiving device, although the process of formation is already completed. In this operating state, the electrochemical cell can contribute to the energy storage. The receiving device, onto which the electrochemical cell arranged for energy storage is then attached, consequently takes on the function of the energy storage device in this operating state, if appropriate in conjunction with the electrochemical cell. In this respect, it is only possible to differentiate between the energy storage device and the production unit by means of a consideration of the current function in the context of the battery production device.

Preferably, the battery production device comprises a network load sensor which can in particular detect a network overload and/or a network underload of the power network. On the basis of the network overload and/or network underload detected, conclusions can be drawn about the power offering in the power network. A network load sensor can for example determine the network frequency of the power network. A network load sensor can be implemented as a software model and/or constructed as a component of the control device. In the case of a surplus of electrical power, an increase of the network frequency may result; in the case of an undersupply, a reduction of the network frequency may result. A network load sensor may alternatively also be a data processing unit which can preferably analyse prepared network load data, which can be transmitted externally via a communication line to the battery production device, and can enable conclusions about the network load. Network load data of this type can also comprise values about current and/or future procurement costs of electrical energy.

The object on which the invention is based is further achieved by means of a method for controlling a battery production device, in particular a formation device for the formation of electrochemical cells, comprising a production unit, in particular a receiving device for receiving at least one electrochemical cell, in particular a plurality of electrochemical cells, a power network connecting device, by means of which the battery production device can draw electrical energy from a power network and can emit electrical energy to the power network, and a control device for controlling at least parts of the battery production. In this case, an offer of electrical power, namely the power offering, is detected in the power network and the extent of energy which is drawn from the power network and/or is emitted to the power network, is determined on the basis of the power offering detected.

The power offering in the power network can be determined using a network load sensor. The extent of energy to be drawn and/or to be emitted can be influenced by further parameters. The advantages already mentioned for the battery production device result.

Preferably, the power offering in the power network is determined on the basis of measurements of the network frequency. Preferably, in this case, the temporary power offering, that is to say the power offering present at the time of the measurement of the network frequency, is determined. Alternatively or in combination therewith, the power offering in the power network can be determined statistically. Here, a temporal power offering can be determined. Alternatively or in combination therewith, a power offering can also be determined at any desired point in time, particularly a point in time in the future. A power offering under comparable basic conditions at earlier points in time can for example be called upon to this end, taking further account of deviating basic conditions if appropriate.

Preferably, in the event of network overload, more electrical energy can be drawn from the power network than in the case of a network underload. For this comparison, practically identical operating states of the battery production device, which only differ from one another by means of the presence of network overload or network underload, are to be drawn upon in each case. Within the control, a function can be implemented, which means that parts of the battery production device draw more energy from an energy storage device in the case of the network underload than would be the case in the event of a network overload. Alternatively or in combination, within the control, a function can be implemented which means that in the case of the network overload, less energy is provided to parts of the battery production device or that parts of the battery production device demand less power than would be the case in the event of network underload.

The terms power underload and power overload are to be understood as relative terms and preferably relate to two states of the power network, the power offering of the power network being lower in the event of network overload or the power offering of the power network being greater in the event of network underload than in the respective other state. This naturally also comprises the states of absolute network overload or absolute network underload, in which the entirety of the power demanded in a power network is greater or smaller than the entirety of the power provided in the power network.

Preferably, in the case of network underload more power is drawn from the power network than in the case of network overload, particularly in the case of otherwise constant conditions. The power drawn is preferably supplied to the production unit and/or an energy storage device. In this respect, a possible power surplus in the power network can be reacted to by means of increased power consumption, as a result of which the production unit can be supplied with more power. Alternatively or in combination, the energy storage device can be provided with more power which can then be provided to the production device if the power offering in the power network is lower at another point in time.

In the event of network overload, more power can be drawn from an energy storage device, particularly for the production unit, than is the case in the event of network underload, particularly in the case of otherwise constant conditions. As a result, a reduced power output of the power network can be replaced by the energy storage device.

Preferably, in the case of network overload more power is introduced into the power network than in the case of network underload, particularly by the production unit and or by an energy storage device, particularly in the case of otherwise constant conditions. It can come to pass, particularly if the production unit is working on the process of the formation, that energy which is stored in electrochemical cells to be processed is drawn from the same. This can be introduced either into an energy storage device or into the power network. It makes sense, in the case of network overload to introduce more energy into the power network. In the case of network underload by contrast, more power can be introduced into the energy storage device, particularly from the power network and/or from the production unit, than in the case of network overload, particularly in the case of otherwise constant conditions. If therefore a larger power offering is available, the energy storage device can therefore be charged. Alternatively or in combination therewith, the electrical power emitted by the production unit can be introduced into the energy storage device to a greater extent than would be the case in the event of network overload.

Preferably, an electrochemical cell, which is processed in an operating state in the production operation, is used as electrochemical cell of an energy storage device in an operating state temporally following the operating state. Particularly if the production unit is used for the formation of electrochemical cells, the electrochemical cells can remain in the battery production device for a certain time following the formation and, if appropriate, be in a charged or partially charged state. In an operating state of this type, the storage capacity of the electrochemical cell can be used for storing electrical energy. In this case, the electrochemical cell can be locally displaced from the receiving device, in which the electrochemical cell was installed during the production process, into another receiving device of the energy storage device in particular. Alternatively, the electrochemical cell can also remain in the receiving device however. In a case of this type, the battery production device is constructed in such a manner that the same can also be used as energy storage device, if appropriate in conjunction with the electrochemical cell installed therein.

Further advantages, features and application possibilities of the present invention result from the following description in connection with the figures. In the figures:

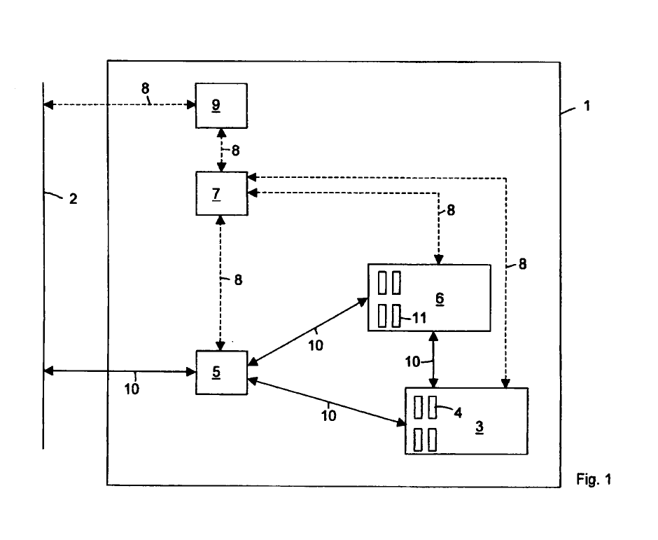

FIG. 1 shows a block diagram of a formation device according to the invention;

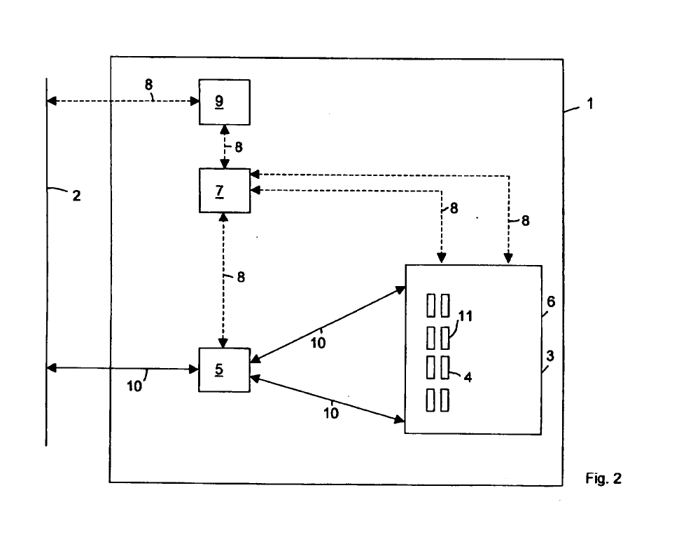

FIG. 2 shows a block diagram of a formation device according to the invention in an alternative embodiment;

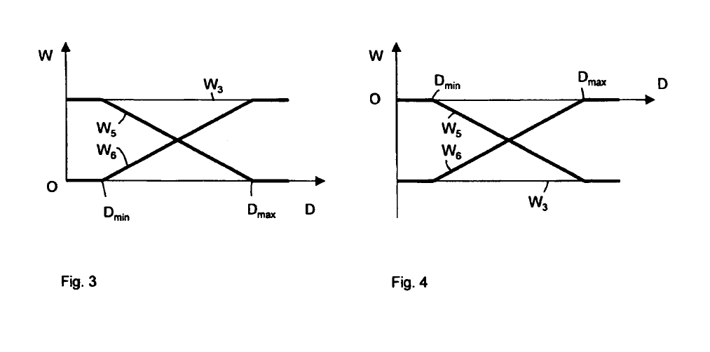

FIG. 3 shows a characteristic of a control for the drawing of power in a first embodiment;

FIG. 4 shows a characteristic of a control for the emission of power of the first embodiment;

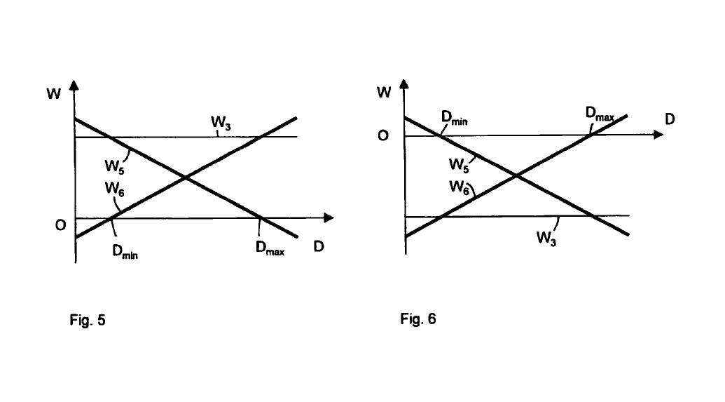

FIG. 5 shows a characteristic of a control for the drawing of power in a second embodiment;

FIG. 6 shows a characteristic of a control for the emission of power of the second embodiment;

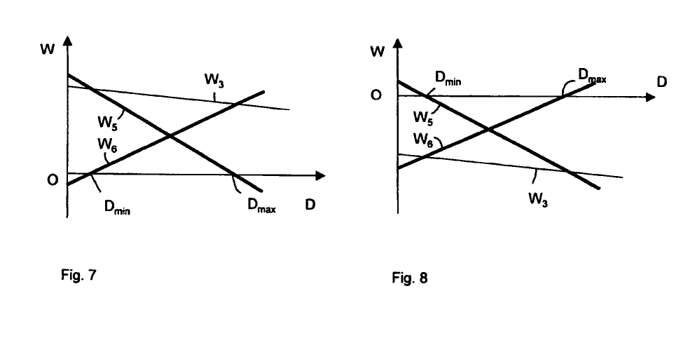

FIG. 7 shows a characteristic of a control for the drawing of power in a third embodiment;

FIG. 8 shows a characteristic of a control for the emission of power of the third embodiment.

FIG. 1 shows a formation device 1 as an example for a battery production device according to the invention. The formation device 1 comprises a receiving device 3 for electrochemical cells 4. The electrochemical cells 4 received in the receiving device 3 are cells of this type, on which within the formation device 1, a production process is undertaken, which in the present case may be formed by formation. Alternatively or in combination therewith, other production processes can also be carried out.

The formation device 1 further comprises a power network connecting device 5 which is connected using a bidirectional power line 10 to a public power network 2. The power network connecting device 5 on the one hand enables the drawing of electrical power from the power network 2. On the other hand, the power network connecting device 5 enables an emission of electrical power from the formation device 1 into the power network 2. The power network connecting device 5 is connected to the receiving device 3 via a further bidirectional power line 10, so that electrical power can be emitted by the power network connecting device 5 to the receiving device 3 and electrical power can be emitted by the receiving device 3 to the power network connecting device 5.

The formation device 1 further has an energy storage device 6. A number of electrochemical cells 11 are arranged in the energy storage device 6. The electrochemical cells 11 arranged in the energy storage device 6 are preferably already finished electrochemical cells on which no production process whatsoever is currently carried out within the formation device. Rather, the electrochemical cells 11 are used in the energy storage device 6 as units for storing electrical energy. The energy storage device 6 is connected via bidirectional power lines 10 to the receiving device 3 and the power network connecting device 5.

The formation device 1 has a control device 7. The control device 7 is connected via bidirectional data lines 10 to the power network connecting device 5, the receiving device 3 and also the energy storage device 6. The control device 7 can control and regulate individual processes within the devices 3, 5, 6 mentioned. In particular, the control device 7 can control or regulate the flow of electrical power within the power lines 10. The control device 7 is connected to a network load sensor 9 via a further data line 8. The network load sensor 9 is constructed to determine a network frequency in the power network 2 so that conclusions can be drawn about the network load within the power network 2. Furthermore, the network load sensor 9 receives data from the local power network supplier via a further data line which is not illustrated, which comprise the degree of network load and also the current energy procurement costs. Energy procurement costs are also to be understood as meaning negative energy procurement costs, namely also the remuneration on the part of the power network operator for electrical power which is fed into the power network by the formation device.

FIG. 2 shows the block diagram of a formation device 1 according to the invention which corresponds substantially with the formation device according to FIG. 1. Only the differences are covered in the following. It is to be recognised that the receiving device and the energy storage device are formed by a common device. Following the formation, the electrochemical cells to be formatted are also stored for a certain period within the receiving device. During this storage, the electrochemical cells, which were previously formatted, may be charged and thus take on the tasks of the electrochemical cells 11 of the energy storage device 6. In this respect, the electrochemical cells 11 of the energy storage device 6 are formed by the electrochemical cells 4 of the receiving device 3 when the formation of these electrochemical cells 4 is completed.

On the basis of the network load determined, the control device controls the drawing of power or the power emission of the individual devices, which is explained with the reference to the FIGS. 3 to 8.

FIG. 3 shows a characteristic of a control for the drawing of power in a first embodiment. The degree of network load D is plotted on the abscissa. Dₘᵢₙ in this case by way of example designates a state of network underload; Dₘₐₓ in this case by way of example designates a state of network overload.

The ordinate designates the electrical power W which is demanded or provided by individual devices. Independently of the degree of network load D, the receiving device requires a constant electrical power W₃. This electrical power W₃ can on the one hand be provided by means of the power network connecting device 5 from the power network 2, illustrated by the line designated with W₅. It is to be recognised that the power W₅ which is drawn from the power network 2 is greater when the network load is lower. If the network load D is greater, the power W₅ drawn from the power network 2 falls. In order nonetheless to satisfy a constant electrical power W₃ of the receiving device 3 demanded, electrical power W₆ is alternatively provided by the energy storage device 6. It can be seen that from a certain network overload Dₘₐₓ, energy is drawn exclusively via the energy storage device 6. Below a certain network underload Dₘᵢₙ, by contrast, power is drawn exclusively by the power network connecting device 5 from the power network 2.

FIG. 4 shows a characteristic of a control for the emission of power of the first embodiment. For example, the electrochemical cells 4 arranged in a receiving device 3 can be discharged. The power curves are located below the abscissa and therefore designate a flow of power in one direction which is orientated counter to the flow of power according to FIG. 3.

It can be seen that the battery receiving device 3 can emit an electrical power W₃. In the case of a network underload, an emission of electrical power to the power network is unfavourable, as a result of which more electrical power W₆ is emitted to the energy storage device. In the case of a network overload, by contrast, power W₅ is emitted to the power network 2 to a greater extent via the power network connecting device 5. It can also be seen that below a certain network underload Dₘᵢₙ, electrical power is exclusively emitted to the energy storage device 6, whilst above a certain network overload Dₘₐₓ, electrical power is exclusively emitted to the power network 2 via the power network connecting device 5.

The FIGS. 5 and 6 show characteristics of a control for the drawing of power or the emission of power in a second embodiment. These essentially correspond to the characteristics of FIGS. 3 and 4, so that only the differences are covered in the following. It is to be recognised in FIG. 5 that in the case of a network underload below a certain network underload Dₘᵢₙ, more electrical power W₅ is drawn via the power network connecting device 5 from the power network 2 than electrical power W₃ is required by the receiving device 3. Further, it is to be recognised that below a certain network underload Dₘᵢₙ, the power W₆ which is provided by the energy storage device takes on a negative value. This results from the fact that a surplus portion of the power W₅ which is provided by the power network connecting device 5 from the power network 2 is used for charging the energy storage device 6. Further, it is to be recognised that above a certain network overload Dₘₐₓ, the energy storage device 6 provides more electrical power W₆ than is required by the receiving device 3. A surplus portion of the power provided by the energy storage device 6 is introduced into the power network 2 in order to contribute to stabilising the network load. As can be recognised, the amount of power W₅ drawn from the power network is negative which means that electrical power is emitted to the power network 2.

FIG. 6 in this case shows the state in which the receiving device can emit electrical power W₃. It is to be recognised that below a certain network underload Dₘᵢₙ, the power W₅ drawn from the power network takes on a positive value. This positive power is emitted to the energy storage device 6. It is to be recognised that the power W₆ which is emitted to the energy storage device 6 is greater than the power W₃ which is emitted by the receiving device 3. Further, it is to be recognised that above a certain network overload Dₘₐₓ, a surplus of electrical power W₆ can be emitted to the power network 2, so that the entire power W₅ emitted to the power network 2 via the power network connecting device 5 is greater than the electrical power W₃ provided by the receiving device 3.

The FIGS. 7 and 8 show characteristics of a control for the drawing of power or the emission of power in a third embodiment. These essentially correspond to the characteristics of FIGS. 5 and 6, so that only the differences are covered in the following. It is to be recognised that the electrical power W₃ required by the receiving device 3 varies as a function of the network load D. So the power W₃ required by the receiving device 3 is reduced by the control device if a high network load D is present, as illustrated in FIG. 7. In the case of a low network load, the energy W₃ required by the receiving device 3 is increased. Analogously, as shown in FIG. 8, the control device can be implemented in such a manner that the receiving device 3 emits more electrical power W₃ in the case of network overload than in the case of network underload as illustrated in FIG. 8.

### REFERENCE LIST

1 Formation device

2 Power network

3 Receiving device

4 Electrochemical cell

5 Power network connecting device

6 Energy storage device

7 Control device

8 Data line

9 Network load sensor

10 Power line

11 Electrochemical cell

D Network load

W Power

1. A battery production device for the formation of electrochemical cells, comprising
a production unit configured to receive at least one electrochemical cell,
a power network connecting device, through which the battery production device can draw electrical energy from a power network and can emit electrical energy to the power network,
a control device configured to control at least parts of battery production, wherein
the control device is constructed in such a way that at least one of the electric power drawn from the power network or the electrical power emitted to the power network can be controlled as a function of power offered in the power network.

2. The battery production device according to claim 1, wherein the battery production device comprises an energy storage device.

3. The battery production device according to claim 2, wherein the energy storage device and the production unit are formed by a common device.

4. The battery production device according to claim 1 the battery production device comprises a network load sensor which can detect at least one of a network overload or a network underload of the power network.

5. A method for controlling a battery production device for the formation of electrochemical cells, comprising a production unit to receive at least one electrochemical cell, a power network connecting device, through which the battery production device can draw electrical energy from a power network and can emit electrical energy to the power network, a control device to control least parts of the battery production, comprising:
detecting an offer of electrical power in the power network; and
determining an extent of energy which is at least one of drawn from the power network or emitted to the power network on the basis of the power offering detected.

6. The method according to claim 5, wherein the power offering in the power network is determined on the basis of measurements of network frequency.

7. The method according to claim 5, wherein to the power offering in the power network is determined statistically.

8. The method according to claim 5, wherein in the case of network underload more power is drawn from the power network than in the case of network overload, for the production unit or for an energy storage device.

9. The method according to claim 5, wherein in the event of network overload more power is drawn from an energy storage device, for the production unit, than is the case in the event of network underload.

10. The method according to claim 5, wherein in the case of network overload more power is introduced into the power network than in the case of network underload.

11. The method according to claim 5, wherein in the case of network underload more power can be introduced into the energy storage device, particularly from the power network and/or from the production unit, than in the case of network overload.

12. The method according to claim 5, wherein an electrochemical cell, which is processed in an operating state in the production operation, is used as an electrochemical cell of an energy storage device in an operating state temporally following the operating state.

13. The battery production device according to claim 1, wherein the production unit receives a plurality of electrochemical cells.

14. The battery production device according to claim 1, wherein the power network is a public power network.

15. The battery production device according to claim 1, wherein the at least one of the electric power drawn from the power network or the electrical power emitted to the power network is controlled as a function of temporary power offered by the power network.

16. The method according to claim 5, wherein the production unit receives a plurality of electrochemical cells.

17. The method according to claim 5, wherein the power network is a public power network.
